(19) United States
(12) Patent Application Publication
(10) Pub. No.: US 2014/0268949 A1
(43) Pub. Date: Sep. 18, 2014

(54) APPARATUS AND SYSTEM OF POWER CONVERSION

(71) Applicant: Kenneth W. Kayser, (US)

(72) Inventor: Kenneth W. Kayser, Catawba, VA (US)

(73) Assignee: Tagnetics, Inc., Troy, OH (US)

(21) Appl. No.: 14/217,902

(22) Filed: Mar. 18, 2014

Related U.S. Application Data
(60) Provisional application No. 61/792,224, filed on Mar. 15, 2013.
(60) Provisional application No. 61/833,179, filed on Jun. 10, 2013.

(51) Int. Cl. G05F 1/56

(52) U.S. Cl. CPC G05F 1/56
USPC 363/74

(57) ABSTRACT

A power converter for use with an area controller system to provide electrical power to electrical devices at the shelves of retail stores. The power converter converts power from the voltage, frequency, and amperage of the area controller system to the voltage, frequency, and amperage of various electrical devices.

### CROSS-REFERENCE TO RELATED APPLICATION

This application claims priority to U.S. Provisional Patent Application Ser. No. 61/792,224 filed Mar. 15, 2013, and U.S. Provisional Patent Application Ser. No. 61/833,179 filed Jun. 10, 2013, the entirety of these applications are incorporated by reference herein.

### FIELD

The present disclosure generally relates to power conversion. More specifically, the present disclosure relates to a power converter which converts power from the voltage, frequency, and amperage of a retail area controller system to the voltage, frequency, and amperage of various electrical devices.

### BACKGROUND

Some retail stores have begun to use various electrical devices at their shelves as a means for conveying information to customers, advertising, or generally attracting customer attention to certain products. Such electrical devices include, for example, video screens, electronic price labels, and coupon displays.

These electrical devices require electrical power. Conventionally, power is supplied via batteries or standard wall outlets. Batteries are problematic for use in this application because of their limited lifespan, limited power output, and high personnel and material costs to replace them. Standard wall outlets allow for unlimited lifespan but require power conversion for most applications. Additionally, neither batteries nor standard wall outlets are capable of supplying electrical power and communicating or controlling the electrical device having various electrical needs simultaneously.

An additional solution to the problem of supplying electrical power to electrical devices on the shelves of retail stores is to use an area controller as described in U.S. Pat. No. 5,537,126. An area controller supplies both power and data to electrical devices. Using inductive coupling, this solution provides a system that both delivers power to the shelf and serves as a means for communicating with and controlling various electrical devices at the shelf. However, when using this method to supply electrical power, the power must be converted from the voltage, frequency, and current of the area controller supply to a voltage, frequency, and current that is compatible with the various electrical devices retailers use at their shelves.

### SUMMARY

In some embodiments, a power converter comprises a power source connection, a diode set, a voltage regulator, a power output connection, and a capacitor connected in parallel with the diode set. In some embodiments, additional capacitors are connected between the voltage regulator and ground.

In some embodiments a system of power conversion comprises a power source, tag area controller, a power stringer, a display, and a power converter comprising a power input connection, a diode set, a voltage regulator, and a power output connection.

In some embodiments a power coupler comprises secondary windings, an ultra-low-power mixed signal microcontroller, a 20V N-channel enhancement mode MOSFET, a high input voltage single inductor buck-boost converter, and a power output connection.

### BRIEF DESCRIPTION OF THE DRAWINGS

The foregoing and other advantages of the invention will become apparent upon reading the following detailed description and upon reference to the drawings.

FIG. 1 is a schematic diagram of a power converter in accordance with some embodiments.

FIG. 2 is a schematic diagram of a power distribution system in accordance with some embodiments.

FIG. 3 is a schematic diagram of a power coupler in accordance with some embodiments.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

The disclosed apparatus and system provide a power converter for converting power from the voltage, frequency, and amperage of a retail area controller system to the voltage, frequency, and amperage of various electrical devices. .

The following description is provided as an enabling teaching of a representative set of examples. Many changes can be made to the embodiments described herein while still obtaining beneficial results. Some of the desired benefits discussed below can be obtained by selecting some of the features or steps discussed herein without utilizing other features or steps. Accordingly, many modifications and adaptations, as well as subsets of the features and steps described herein are possible and can even be desirable in certain circumstances. Thus, the following description is provided as illustrative and is not limiting.

This description of illustrative embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present disclosure. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that a system or apparatus be constructed or operated in a particular orientation. Terms such as “attached,” “affixed,” “connected” and “interconnected,” refer to a relationship wherein structures are secured or attached to one another either directly or indirectly through intervening structures, as well as both movable or rigid attachments or relationships, unless expressly described otherwise. The term “adjacent” as used herein to describe the relationship between structures/components includes both direct contact between the respective structures/components referenced and the presence of other intervening structures/components between respective structures/components.

As used herein, use of a singular article such as “a, “an” and “the” is not intended to exclude pluralities of the article's object unless the context clearly and unambiguously dictates otherwise.

FIG. 2 is a schematic diagram of a power distribution system 200 for at least one display 10 in accordance with some embodiments. In some embodiments, power distribution system 200 distributes power to a plurality of displays 10. In some embodiments, power distribution system 200 distributes power to a plurality of electronic shelf labels (ESLs) 203.

In some embodiments power source 29 is a standard wall outlet well known in the art. Electrical power flows through a Power TAC 28 to a power stringer 26. In some embodiments the power stringer 26 is called the primary distribution loop. In some embodiments power stringer 26 distributes power at between 45 and 50 VAC, 50 KHz, and 1 ampere. A frequency of 50 KHz was selected in part to comply with applicable regulatory requirements.

In some embodiments, Power TAC 28 is a Tag Area Controller as used in a system of electronic shelf labels such as that disclosed in U.S. Pat. Nos. 5,537,126; 5,736,967; 6,249,263; 6,271,807; and 6,844,821. In other embodiments, Power TAC 28 may be removed allowing each power converter to connect to the power source 29. In some embodiments, the Power TAC 28 is an electrical power strip. From power converter 100 power is provided to a display 10. In some embodiments, the control for a Power TAC 28 is provided by a general purpose computer processor.

Power stringer 26 conveys power from the Power TAC 28 to at least one display 10. Each display 10 is connected to the power stringer 26 via a power converter 100. In some embodiments, power stringer 26 additionally conveys power to at least one secondary distribution loop 201. A secondary distribution loop 201 may also be referred to as a riser. Each secondary distribution loop 201 is connected to power stringer 26 via a primary-secondary connection 202. In some embodiments, the primary-secondary connection 202 is a step-down transformer which maintains the secondary distribution loop 201 at a lower voltage, frequency, and/or amperage than the power stringer 26. In other embodiments, the primary-secondary connection 202 maintains the secondary distribution loop 201 at the same voltage, frequency, and amperage as power stringer 26.

In the embodiment pictured in FIG. 2, a plurality of displays 10 are connected to a single power source 29 using a single stringer 26 and a plurality of power converters 100. In some embodiments, a plurality of displays 10 may receive electrical power by a plurality of power sources 29 or a plurality of power stringers 26.

In some embodiments, a display 10 is a video monitor, tablet computer, or smart phone. In some embodiments, a display 10 is lighting mounted to a shelf, such as under-mounted shelf lighting. In some embodiments, display 10 is a lighted promotional glass display.

FIG. 1 is a schematic diagram of a power converter 100 in accordance with some embodiments of the present disclosure. FIG. 1 shows a power source 101 connected to node 107 and node 108 through a power source connection 114 and a first line 116 and second line 117. Capacitor 102 is connected across the first and second lines 116 and 117 leading to first node 107 and second node 108, and in parallel with a diode set 118. In some embodiments, capacitor 102 is rated at 0.22 μF.

In some embodiments, the power source 101 illustrated in FIG. 1 is power stringer 26 illustrated in FIG. 2. In some embodiments, power source connection 114 is connected to power stringer 26 via inductive coupling. In some embodiments, the electrical power received at power source connection 114 is received from power stringer 26 via a transformer.

Diode 103 and diode 104 form a first diode string 119 connected to first node 107. Diode 105 and diode 106 form a second diode string 120 connected to second node 108. The first diode string 119 and second diode string 120 are connected in parallel to form a diode set 118. The diode set 118 is connected to ground and to the remainder of the circuit.

The cathode of diode 103 is connected to first node 107 and the anode is connected to ground. The cathode of diode 104 is connected to microchip 111 and the anode is connected to first node 107. The cathode of diode 105 is connected to second node 108 and the anode is connected to ground. The cathode of diode 106 is connected to microchip 111 and the anode is connected to ground. Diodes 103 and 105 prevent current flow from power source 101 to ground. Diodes 104 and 106 prevent reverse current flow from power output 113 in the direction of power source 101.

The output of the diode set 118 is connected as the input to a microchip 111. In some embodiments, microchip 111 is a complementary metal oxide semiconductor (CMOS) low dropout (LDO) voltage regulator which is connected to an input, an output, and a ground. In some embodiments, the microchip 111 is a DC linear voltage regulator designed to maintain a constant voltage output. In some embodiments, the microchip 111 is the CMOS LDO voltage regulator numbered MCP1700T5002 and available from various microchip manufacturers. In some embodiments, the microchip 111 is an analog voltage regulator.

In some embodiments, capacitors 109 and 110 are connected between the diode set 118 and ground in parallel with the microchip 111 input line. In some embodiments, capacitors 109 and 110 are rated at 220 μF. Capacitor 112 is connected between the microchip output line and ground in parallel with the power output 113. In some embodiments, capacitor 112 is rated at 10 μF.

The output of microchip 111 is supplied to the power output 113 through power output connection 115.

In some embodiments, an area controller system supplies power to the power converter 100 at an alternating current voltage between 45 and 50 volts, a frequency of 50 KHz, and an amperage of approximately 1 ampere. In some embodiments, the power input into power converter 100 is supplied from a power source 29 through a Power TAC 28 to a power stringer 26. In other embodiments, the power source 101 is a standard electrical outlet. In various embodiments, this standard electrical outlet supplies electrical current at 120 volts, 60 Hz, and approximately 15 amperes.

In some embodiments, the power converter 100 has a power output 113 of 5 volts DC and 2 amps. In some embodiments, the power converter 100 has a power output 113 of 12 volts DC and 2 amps. In some embodiments, the power converter 100 has a power output 113 of 19 volts DC and 3 amps. In some embodiments, the power converter 100 has a power output 113 of 24 volts DC and 3 amps. These various power outputs are achieved by altering one or more of the current flow of the power stringer 26, the number of turns in the primary of secondary windings of the transformer connecting power stringer 26 to power converter 100, or the ratings of the various diodes, capacitors, and voltage regulator of power converter 100.

In some embodiments, the power converter 100 outputs a power at standard USB power of a DC voltage of 5 volts and an amperage of 200 milli-amperes. In some embodiments, the approximate current, voltage, and frequency of the power converter 100 output, is within industry accepted standards. In other embodiments, the approximate current, voltage, and applicable frequency of the power converter 100 output, is within ten percent of the power source's 101 ratings. In other embodiments, the supplied power can come from a number of sources, including a conventional electric grid or locally-generated solar or wind power.

The presently disclosed power converter can be used with innumerable electrical devices. In some embodiments, display 10 which is connected to power converter 100 is a video monitor, coupon generator, electronic price label, out-of-stock sensor, inventory sensor, interactive device, promotional display, customer feedback device, or tablet.

The presently-disclosed power converter is additionally advantageous because it can serve as a conduit for communication signals between the area controller and electrical device. For example the presently-disclosed power converter can be used to provide power and communications to the systems disclosed in pending U.S. patent application Ser. No. 14/152,644 and U.S. patent application Ser. No. 14/152,678, commonly owned with the present application, the disclosure of which are hereby incorporated by reference.

Referring again to FIG. 2, in some embodiments secondary distribution loop 201 conveys power and communication signals to a plurality of electronic shelf labels 203 and similar electronic devices. An electronic shelf label 203 is connected to secondary distribution loop 201 via a power coupler 204. In a retail environment, in some embodiments a secondary distribution loop 201 is assigned to each aisle or each side of an aisle of retail shelves. In some embodiments, the electronic shelf label 203 illustrated in FIG. 2 is replaced with another of various electronic devices which include a video monitor, coupon generator, out-of-stock sensor, inventory sensor, interactive device, promotional display, customer feedback device, or tablet.

One embodiment of a power coupler 204 is illustrated as FIG. 3. In some embodiments, power coupler 204 comprises an ultra-low-power mixed signal microcontroller 321, a 20V N-channel enhancement mode MOSFET 329, and a high input voltage single inductor buck-boost converter 311. In some embodiments, electrical power enters the power coupler 204 via secondary windings 312 which are operably coupled to primary windings (not shown) in the secondary distribution loop. In some embodiments, electrical power exits the power coupler 204 via power output connection 320. In some embodiments, the power output of power coupler 204 is configured to meet the needs of a specific electronic device which is operably connected to power coupler 204. The power output of power coupler 204 typically ranges from 1 W to 5 W, although this range is not limiting on the present disclosure. The power output of power coupler 204 is altered by changing one or more of the current flow of the secondary distribution loop 201, the number of turns in the primary of secondary windings of the transformer connecting secondary distribution loop 201 to power coupler 204, or the ratings of the various diodes, capacitors, and voltage regulator of power coupler 204.

The present disclosure can be implemented by a general purpose computer programmed in accordance with the principals discussed herein. It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, app, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network or as an app on a mobile device such as a tablet, PDA or phone.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer or mobile device. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms data memory including non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), LCD (liquid crystal display) monitor or other monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What we claim is:

1. A power converter comprising:
a power source connection;
a first line from the power source connection to a first node;
a second line from the power source connection to a second node;
a diode set connected to ground, a voltage regulator, and the first and second nodes comprising:
a first diode string connected to the first node comprising:
a first diode wherein its cathode connected to the first node and its anode connected to ground; and
a second diode wherein its anode connected to the first node and its cathode connected to the voltage regulator; and
a second diode string connected to the second node, connected in parallel with the first diode string, comprising:
a third diode wherein its cathode is connected to the second node and its anode is connected to ground; and
a fourth diode wherein its anode is connected to the second node and its cathode is connected to the voltage regulator;
a power output connection connected between the voltage regulator and ground;
a first capacitor connected to the first and second lines in parallel with the diode set;
a second capacitor and a third capacitor connected between the diode set and ground in parallel with the voltage regulator; and
a fourth capacitor connected between the voltage regulator and ground in parallel with a power output connection.

2. The power converter of claim 1, wherein the voltage regulator is a direct current linear voltage regulator.

3. The power converter of claim 1, wherein the voltage regulator is a microchip.

4. The power converter of claim 3, where in the microchip is a complementary metal oxide semiconductor low dropout voltage regulator.

5. The power converter of claim 4, wherein the microchip is a MCP 1700T5002-type complementary metal oxide semiconductor low dropout voltage regulator.

6. The power converter of claim 1, wherein the power source connection receives alternating current voltage between 45 and 50 volts at a frequency of 50 KHz with an amperage of approximately 1 ampere.

7. The power converter of claim 1, wherein the power source connection receives alternating current voltage of approximately 120 volts at a frequency of 60 Hz with an amperage of approximately 15 amperes.

8. The power converter of claim 1, wherein the power output is 200 milli-amperes direct current at 5 volts.

9. A power converter comprising:
a power source connection;
a diode set connected in parallel with a first capacitor, the diode set further connected to ground and a voltage regulator; and
a power output connection connected between the voltage regulator and ground, wherein the voltage regulator is a complementary metal oxide semiconductor low dropout voltage regulator.

10. The power converter of claim 9 further comprising:
a second capacitor and a third capacitor connected between the diode set and ground in parallel with the voltage regulator; and
a fourth capacitor connected between the voltage regulator and ground in parallel with a power output connection.

11. The power converter of claim 10, wherein the power source connection receives alternating current voltage between 45 and 50 volts at a frequency of 50 KHz with an amperage of approximately 1 ampere.

12. A power converter system comprising:
a power source connection receiving alternating current voltage between 45 and 50 volts at a frequency of 50 KHz with an amperage of approximately 1 ampere;
a first line from the power source connection to a first node;
a second line from the power source connection to a second node;
a complementary metal oxide semiconductor low dropout voltage regulator microchip;
a diode set connected to ground, the microchip, and the first and second nodes comprising:
a first diode string connected to the first node comprising:
a first diode wherein its cathode connected to the first node and its anode connected to ground; and
a second diode wherein its anode connected to the first node and its cathode connected to the microchip; and
a second diode string connected to the second node, connected in parallel with the first diode string, comprising:
a third diode wherein its cathode is connected to the second node and its anode is connected to ground; and
a fourth diode wherein its anode is connected to the second node and its cathode is connected to the microchip;
a power output connection connected between the microchip and ground;
a first capacitor connected to the first and second lines in parallel with the diode set;
a second capacitor and a third capacitor connected to the diode set and ground in parallel with the microchip; and
a fourth capacitor connected to the microchip and ground in parallel with a power output connection.
